(19) United States
(12) Patent Application Publication
(10) Pub. No.: US 2002/0114865 A1
(43) Pub. Date: Aug. 22, 2002

(54) Celery product and method for its production

(76) Inventors: William V. Greathouse, Sorrento, FL (US); Clyde E. Shearer, Mount Dora, FL (US)

Correspondence Address: BREZINA & EHRLICH, Suite 333, 47 West Polk Street, Chicago, IL, 60605-2092, US

(21) Appl. No.: 09/790,000

(22) Filed: Feb. 21, 2001

(51) Int. Cl. A23C 9/12

(52) U.S. Cl. 426/43

(57) ABSTRACT

A celery product is produced by the steps of optionally cutting the celery to a predetermined length, cooking the celery for a period of about 60-120 seconds in an aqueous medium at a pH of about 1.0 to 1.5 and a temperature of at least 190° F., transferring the cooked celery to an aqueous medium in a filling machine at an initial pH of about 2.4 to 2.6, transferring the celery from the filling machine to a sealable container filled with water at a temperature of about 190° F., sealing the container and allowing the water to cool to form a vacuum packed celery product having a pH of about 3.5 to 4.2. The celery product is shelf stable for long periods of time and retains the flavor and texture of fresh celery due to the short cooking time.

### BACKGROUND OF THE INVENTION

The invention relates to a cooked and packaged celery product and a method for producing the product.

Over the years, celery has been developed into three types with fairly different uses.

Stalk celery is the most prevalent in the United States and Western Europe. This celery has been developed to have large, fairly flat to cupped stems with a solid, crisp interior. Frequently, the top-most leaves and roots are removed before sale and consumption. Stems with entire leaves are available for consumption in the center of the plant, called the heart, and these stems are sold like outer stems. Breeding has been used to make stalk celery greener, milder flavored and generally more solid and crisp.

Root celery is often grown in climates too cold for stalk celery. Unlike stalk celery, root celery has been developed to have an enlarged root bulb often weighing one to two pounds. The stems, leaves and small roots are removed from this swollen root ball, which is used much like the potato, and which may be fried or mashed, or used in stews and soups. The stems and leaves are often more bitter than those of stalk celery. The stems may be hollow, solid, or in between.

Leaf celery has been developed primarily for leaf and seed production. Often grown in Mediterranean climates, leaf celery more closely resembles celery's wild ancestors. The stems are small and vary from solid to hollow and the leaves are fairly small and vary from mild to bitter. This type is often used for its medicinal properties.

Celery is most often sold fresh, and has therefore a limited shelf life. While canning is possible, canned foods are generally heat processed so that the food can remain at room temperature indefinitely without spoilage. The heat processing must be sufficient to provide the food with “commercial sterility”, a term which is defined to mean a condition when equipment and containers are free of viable microorganism with public health significance, as well as those of non-health significance, capable of reproducing under normal conditions of storage and distribution.

The degree of heat treatment necessary to render a food product commercially sterile is dependent on the pH of the product. Organisms which are heat tolerant, and exist in food products having a pH less than about 4.2, can be destroyed with a relatively mild treatment, i.e. a few minutes of heating at a minimum of 190° F. The duration of this process is temperature and pH dependent.

For foods with a pH higher than about 4.5, more severe conditions are necessary to destroy microorganisms such as Clostridium botulinum, which presents a considerable threat to public health. Complete destruction of these microorganisms requires heating to a temperature of at least 240° F. for a period of time in the range of 20 to 40 minutes, depending on the type of food, and cooking under such conditions drastically alters the color, texture and flavor of the cooked product, as well as adversely affecting the nutritional value of the food.

### SUMMARY OF THE INVENTION

It is therefore an object of the invention to provide a canned celery product which substantially retains the flavor and texture of raw celery, but which is commercially sterile.

To achieve this and other objectives the invention is directed to a method for producing a celery product, comprising the steps of:

optionally cutting raw celery to a predetermined length;

cooking raw celery for a period of about 60-120 seconds adding an aqueous medium at a pH of about 1.0 to 1.5 and a temperature of at least 190° F.;

transferring the cooked celery to an aqueous medium in a filling machine at an initial pH of about 2.4 to 2.6;

transferring the celery from the filling machine to a sealable container filled with water at a temperature of at least 190° F.; and

hermetically sealing the container and allowing the water to cool to form a packaged celery product having a final pH in the range of 3.5 to 4.2.

The invention further relates to a commercially sterile, packed celery product containing celery in an aqueous liquid having a pH of about 3.5 to 4.2, the packaging for the product generally being jars or cans, but possibly extending to flexible plastic packaging or drums. The aqueous liquid may contain flavorings, as desired, and the product shall be packed under vacuum.

The product of this process is advantageous in that it retains the flavor and texture of raw celery, but requires no preparation (cleaning, stripping) on the part of the consumer. Thus, it is especially useful for restaurant applications where it can be placed directly into salads, soups, and sauces.

### DETAILED DESCRIPTION OF THE INVENTION

The raw celery used for the invention is initially treated by cleaning, stripping and cutting, as may be desired for the final product. The raw celery may be cut to desired length. The celery shall be cut before high temperature processing begins.

The initial processing steps may include cleaning steps typically used for raw vegetables, including blowing, cutting, washing, hand grading and inspection, and passage by a metal detector, to assure cleanliness, quality, and food safety.

The cleaned and optionally cut celery is typically conveyed by belt to a continuous cooker, where it is cooked in an aqueous medium, such as a solution of citric acid and water, with a pH of 1.0 to 1.5 the amount of citric acid being sufficient to lower the pH of the celery to about 3.5 to 4.2. This solution may also contain flavorings, such as sugar, usually sucrose, and salt (sodium chloride). A typical treatment solution might contain 100 lbs. of citric acid, 35 lbs. of sugar and 7.5 lbs. of salt in 40 gallons of water. The celery is cooked in this solution for a period of 60 to 120 seconds, preferably about 90 seconds, at a temperature of at least 190° F., and up to 212° F. By adjusting the pH of the medium, the temperature of treatment need not exceed 212° F., so pressure cooking is not required.

The cooked celery exits the cooker into a tumble filler containing an initial solution at pH 2.4 to 2.6, and is tumble filled into cans or jars which are topped off with hot water at a temperature of 190-200° F., and then sealed, forming a vacuum in the container. At the time of sealing, the pH of the product is about 3.5 to 4.2, and the product will continue to buffer the acid as it cools, resulting in a final product having a pH of about 3.5 to 4.2. In the cooling process, the temperature of the canned product is reduced from approximately 190° F. to approximately 120° F. by conveying the containers through a cool water bath for a period of no more than about 40 minutes.

The product obtained may be used as an additive for salads, sauces, stuffings, soups, stews and baking products. For commercial applications, the product may be sold in 55 gallon drums or plastic containers, as well as in cans and jars for home and restaurant use.

### EXAMPLE

Cut celery is delivered in bulk to a processing plant in 1200 pound bins at 38° F. These bins are delivered to a twin dump system and the celery is transferred to a screw to drop through a metal detector, and into a key leaf blower. The celery is then delivered to washers where hot water is introduced to bring the product to 100° F.

The cleaned celery is inspected on a belt and delivered to a surge tank, where it is conveyed by twin augers to an upper production level, where it is delivered to a continuous cooker. A solution is added to the cooker containing 100 lbs. citric acid, 35 lbs. sucrose and 7.5 lbs. sodium chloride in 40 gallons of water. The celery remains in the cooker for 60 to 120 seconds at 200° F., and exits through a chute to a Solburn tumble filler at a pH of 3.5 to 4.2. The celery is filled into 603-700 cans or other sizes, which are filled by a hot water at a range 190-195° F. The filled cans enter an Angelus seamer which inverts the cans to the lids and seals the cans. The cans then travel over timed conveyors for 3-7 minutes to a cooling tunnel. The tunnel is approximately 80 feet long, and the cans remain in the tunnel for 10 minutes. As the cans exit the tunnel, the temperature has been reduced to 110° F.

After cooling, the cans are filled into cartons and passed on conveyors for palletizing. The palletized cans are placed in a wind tunnel to complete cooling to ambient temperature.

The final canned product has a shelf life of about 12 months.

What is claimed is:

1. A method for producing a celery product, comprising the steps of:
custom cutting the celery to a desired length;
cooking the celery for a period of about 60-120 seconds in an aqueous medium at a pH of about 1.0 to 1.5 and a temperature of at least 190° F.;
transferring the cooked celery to an aqueous medium in a filling machine at an initial pH of about 2.4 to 2.6;
transferring the celery from the filling machine to a sealable container filled with water at a temperature of about 190°-200° F.;
sealing the container and allowing the water to cool to form a vacuum packed celery product having a pH of about 3.5 to 4.2.

2. The method of claim 1, wherein the celery is cooked in an aqueous medium comprising an aqueous solution of citric acid.

3. The method of claim 2, wherein the medium further comprises sugar and sodium chloride.

4. The method of claim 1, wherein the sealable container is a metal can.

5. A commercially sterile, packed celery product comprising celery in an aqueous liquid having a pH of about 3.5 to 4.2.

6. The celery product of claim 5, which is vacuum packed.
